(19) United States
(12) Patent Application Publication
(10) Pub. No.: US 2007/0182330 A1
(43) Pub. Date: Aug. 9, 2007

(54) Lamp with improved lamp behaviour during initiation of the lamp

(75) Inventor: Gerardus Marinus Josephus Franciscus Luijks, Nuenen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,754

(22) PCT Filed: Feb. 9, 2005
(86) PCT No.: PCT/IB05/50503

§ 371 Date: Aug. 7, 2006

(30) Foreign Application Priority Data
Feb. 11, 2004 (EP) 04100519.0

(51) Int. Cl. H01J 61/04; H01J 17/04

(52) U.S. Cl. 313/631

(57) ABSTRACT

The invention relates to a Lamp, whereby the lamp comprises electrodes for which in the initial state during run-up of the lamp under 3.2 A run-up current the average increase of electrode tip temperature for the first 25 ms after lighting of the lamp is ≦140 K/ms and ≧3 K/ms.

The invention relates to a lamp with improved lamp behaviour during initiation of the lamp.

Today's lamps, especially HID (high intensity discharge) lamps which are e.g. used in motor vehicles, are designed for optimal performance at the nominal lamp current which is used during usual steady-state performance of the lamp. For 35 W Hg-free automotive lamps this current is typically 0.8 A. However, during run-up of this lamp, where “instant light” needs to be established between the two electrodes of the lamp, a higher, usually quadrupled run-up current is used, which will then be in the range of 3.2 A. This run-up current is in most applications only employed for about ten seconds, after which the very much lower steady state current is employed.

However, when employing lamps of the state of the art, there is the danger, that during the initiation of the lamp, when the lamp current is higher than during long-time performance conditions, this will lead to deterioration of the electrodes. This goes especially for those cases where the electrode tips will become so hot that they will start to melt. This may lead to bulb overheating, instabilities and even lamp failure.

Therefore it is an object to provide a lamp that has improved lamp behaviour during initiation of the lamp, while still meeting the demands in the field, especially under long-time performance.

This object is achieved by a lamp, preferably a Hg- free lamp whereby the lamp comprises electrodes with a cylindrical section and a head section which are adjusted such that in the initial state during run-up of the lamp under 3.2A run-up current the average increase of electrode tip temperature for the first 25 ms after lighting of the lamp is ≦140 K/ms, preferred ≦135 K/ms, more preferred ≦130 K/ms, yet more preferred ≦125 K/ms and most preferred >120 K/ms and ≧3 K/ms. “Lighting” in the sense of the present invention means in particular the initiation of discharge in the lamp. This is usually identical with the switch-on of power supply to the lamp, unless the lamp is lighted with some ignition delay; in this case the lighting would be start after this ignition delay.

The inventor has studied the problems concerning the initiation behaviour of the lamp, especially the deterioration of the lamp performance and has found out, that the very initial period after lighting of the lamp is decisive. If the electrode rod has a temperature profile in which the average increase of electrode tip temperature for the first 25 ms after lighting of the lamp is ≦140 K/ms, preferred ≦135 K/ms, more preferred ≦130 K/ms, yet more preferred ≦125 K/ms and most preferred ≦120 K/ms, most of the problems occurring with lamps of the state of the art concerning the initiation phase, in which a higher current is applied, can be significantly be reduced, if not totally overcome. It should be noted, that in the usual run-up phase of a lamp, high initial current in the range of 3.2A is applied to the lamp several seconds. However, the first milliseconds determine the electrode temperature behaviour, especially concerning possible deterioration of the lamp performance during the run-up phase of the lamp.

According to a preferred embodiment of the present invention, the lamp comprises an electrode with a cylindrical section and a head section which are adjusted such that in the initial state during run-up of the lamp under 3.2A run-up current the average increase of electrode tip temperature for the first 100 ms after lighting of the lamp is ≦50 K/ms preferred >45 K/ms, more preferred ≦40 K/ms, yet more preferred ≦35 K/ms and most preferred ≦30 K/ms and ≧3 K/ms. By using such an electrode, the above-mentioned problems can be reduced even more significantly.

In order to find out about the preferred designs of a lamp which is capable of meeting the objects of the invention as set out above, the inventors have thoroughly studied, which design of a lamp is best suited. Amongst other features, the following design principles have found out to be important:
a) The total volume of the burner chamber must be kept within certain margins, as well as:
b) the volume of the burner chamber, which surrounds each of the electrodes and
c) the volume of the burner chamber which is located between the electrodes

Preferably the burner chamber is divided into two essentially semi-ellipsoidal sections, which are referred to as A and B and a third section to be referred to as C. A covers the volume, which extends from one electrode tip along this electrode to the inner wall section of the burner chamber which contains the electrode; B covers the volume, which extends from the other electrode tip along this electrode to the inner wall section which contains the electrode; Section C covers the remaining volume, which is the area between the electrodes. Preferably the sections A and B have essentially the same volume.

According to a preferred embodiment of the present invention, the total volume of the burner chamber is ’15 mm³ and ≦30 mm³, preferably ≧19 mm³ and ≦25 mm³ and most preferred ≧21 mm³ and ≦23 mm³.

According to a preferred embodiment of the present invention, the total volume of at least one of the sections which extends from one electrode tip along this electrode to the inner wall section of the burner chamber which contains the electrode (A;B) is ≧2 mm³ and ≦3.5 mm³, preferably ≧2.4 mm³ and ≦3.0 mm³ and most preferred ≧2.5 mm³and ≦2.7 mm³. Preferably both sections A and B have a volume which is ≧2 mm³ and ≦3.5 mm³, preferably ≧2.4 mm³ and ≦3.0 mm³ and most preferred ≧2.5 mm³ and ≦2.7 mm³.

According to a preferred embodiment of the present invention, the volume of the burner chamber between the two electrodes (C) is ≧210 mm³ and ≦25 mm³, preferably ≧13 mm³ and ≦20 mm³ and most preferred ≧15 mm³ and ≦18 mm³.

Furthermore, the inventors have found out that also the length of the electrodes inside the burner chamber (to be referred to by D) plays a role in achieving the objects set above. According to a preferred embodiment of the present invention, the length of the electrodes inside the burner chamber (D) is ≧1.0 mm and ≦4.0 mm, more preferably ≧1.5 mm and ≦3.0 mm and most preferred ≧1.8 mm and ≦2.3 mm.

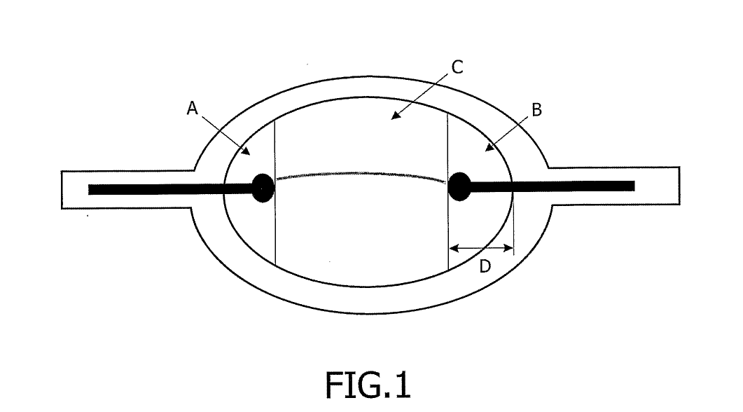

For further illustration it is referred to FIG. 1, in which the volumes A,B and C and the length D is shown for an insofar preferred embodiment of the present invention.

According to a preferred embodiment of the present invention, the inner pressure of the lamp is ≧6 bar and ≦12 bar, preferably ≧8 bar and ≦10 bar Xe in “turned-off” state and /or ≧50 bar and ≦90 bar, preferably ≦64 bar and ≦80 bar in “turned-on” state. The salt pressure in the burning lamp is ≦0.6 bar and ≦1.4 bar, preferably ≧0.8 bar and ≦1.2 bar and most preferred approx. 1 bar.

A preferred filling of the lamp comprises ≧90-≦360 μg NaI; and/or ≧60-≦180 μg ScI₃; and/or ≧0-≦100 μg ZnI₂ and/or ≧0-≦12 μg InI, and/or ≧0-≦12 μg ThI₄ and/or ≧8-10 bar Xe-gas

It should be noted, that a lamp according to the present invention does not only show a good run-up behaviour but also has excellent characteristics during long-time-performance while a much lower current is employed. Therefore, the design of the lamp has to be chosen in that way, that also the standards for a performance under usual steady-state conditions are met. However, simple rod-type electrodes as are now widely used in the state of the art are not suitable to meet these two requirements mentioned above, especially if the range of current that is covered is rather broad, e.g. varying by a factor of 4 over a range of 2.4A.

Thin rods reach too high temperatures and burn shorter in the run-up phase, leading to subsequent problems such as bulb overheating, instabilities and lamp failure.

Thick rods behave unstable in the long-time performance phase as the cathode wants to go to a spot attachment as a result of too strong conduction cooling. Furthermore the conduction losses during the performance of the lamp are too high to, meet the standards in the field. Also, the heat flow to the pinch of the lamp (=conducted power loss) is such that the end temperatures rise too high and cause short lifetimes due to pinch cracking. Moreover, the small feedthrough region especially of today's automotive lamp bears a limitation for the rod thickness, which therefore cannot exceed beyond a certain point.

The inventor has spent much time investigating in this regard and found out, that preferably the lamp comprises electrodes with a cylindrical section and a head section, whereby the maximum diameter of the head section is larger than the maximum diameter of the cylindrical section. By using such electrodes, the demands in the field concerning the optimal performance at lower currents, such as 0.8A during the steady-state performance of the lamp can be fulfilled easily.

It has been found out, that the characteristics and design of the cylindrical section of the electrodes is in particular important for the long-time performance characteristics of the lamp, whereas the characteristics and design of the head section of the electrodes to be used is in particular important for the run-up behaviour of the lamp. Both the cylindrical section and the head section must be matched and adjusted against each other in order to achieve a lamp with the needed performance characteristics. The dimensions should be chosen, such that
a) for the run-up the behaviour of the temperature profile is improved and no deterioration occurs
b) for the nominal current the anode temperature is about the same or slightly higher than the cathode temperature and
c) heat conduction and power losses are minimal

Therefore, according to a further preferred embodiment of the present invention, the maximum diameter of the cylindrical section is of ≧150 μm and ≦400 μm, preferably of ≧200 μm and ≦350 μm and most preferred of ≧250 μm and ≦300 ρm.

Furthermore it is preferred that the maximum diameter of the head section is of ≧250 μm and ≦800 μm, preferably of ≧350 μm and ≦600 μm and most preferred of ≧400 μm and ≦450 μm. Electrodes employing these geometrical shapes have already proven themselves in practice.

According to a further preferred- embodiment of the present invention, the head section has a essentially spherical shape. The sphere diameter is preferably of ≧400 μm and ≦600 μm. Alternatively, according to another further preferred embodiment of the present invention, the head section has a essentially cylindrical shape. The preferred cylinder diameter is of ≧250 μm and ≦500 μm, preferably of ≧320 μm and ≦420 μm and its length is preferably of ≧400 and ≦1200 μm.

According to a further preferred embodiment of the present invention, the maximum diameter of the head section is of ≧20 μm and ≦250 μm, preferably of ≧50 μm and ≦150 μm larger than the maximum diameter of the cylindrical section. An electrode employing this feature will become not too bulky while still having the advantages within the present invention.

According to a further preferred embodiment of the present invention, the head section has a longitudinal length of between ≧150 μm and ≦1500 μm, preferably between ≧400 μm and ≦1200 μm and most preferred between ≧700 μand ≦1000 μm. By doing so, the head section of the electrode will become not too bulky.

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

Additional details, characteristics and advantages of the object of the present invention are disclosed in the subclaims and the following description of the respective figures—which in an exemplary fashion—show preferred embodiments of the lamp according to the invention.

FIG. 1 shows a cross-sectional schematic view through a lamp according to one embodiment of the present invention;

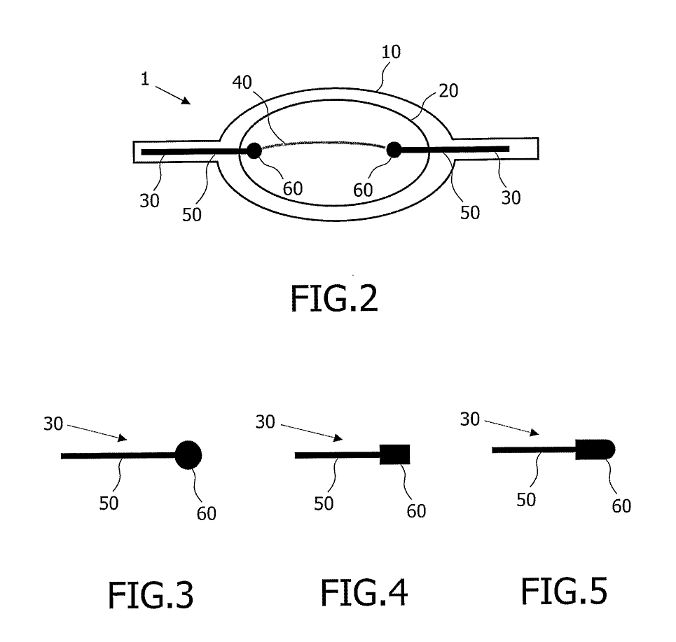

FIG. 2 shows a cross-sectional schematic view through a lamp according to one embodiment of the present invention; and

FIG. 3 shows a schematic enlarged view of the electrode rod of FIG. 1,

FIG. 4 shows a schematic enlarged view of the electrode rod according to a further embodiment of the present invention,

FIG. 5 shows a schematic enlarged view of the electrode rod according to a further embodiment of the present invention; and

FIG. 1 shows a cross-sectional schematic view through a lamp according to one embodiment of the present invention. Preferably the burner chamber is divided into two semi-ellipsoidal sections, which are referred to as A and B and a third section to be referred to as C. A covers the volume, which extends from one electrode tip along this electrode to the inner wand section of the burner chamber which contains the electrode; B covers the volume, which extends from the other electrode tip along this electrode to the inner wand section which contains the electrode; Section C covers the remaining volume, which is the area between the electrodes. Preferably the sections A and B have essentially the same volume. According to a preferred embodiment of the present invention, the total volume of the burner chamber is ≧15 mm³ and <30 mm³, preferably ≧19 mm³ and ≦25 mm³ and most preferred ≧21 mm³ and ≦23 mm³. According to a preferred embodiment of the present invention, the total volume of at least one of the sections which extends from one electrode tip along this electrode to the inner wand section of the burner chamber which contains the electrode (A;B) is ≧2 mm³ and ≦3.5 mm³, preferably ≧2.4 mm³ and ≦3.0 mm³ and most preferred ≧2.5 mm³ and ≦2.7 mm³. Preferably both sections A and B have a volume which is ≧2 mm³ and ≦3.5 mm³, preferably ≧2.4 mm³ and ≦3.0 mm³ and most preferred ≧2.5 mm³ and ≦2.7 mm³. According to a preferred embodiment of the present invention, the volume of the burner chamber between the two electrodes (C) is ≧10 mm³ and ≦25 mm³, preferably ≧13 mm³ and ≦20 mm³ and most preferred ≧15 mm³ and ≦18 mm³. Furthermore, the length of the electrodes inside the burner chamber (as indicated by D) preferably is ≧1.0 mm and ≦4.0 mm, more preferably ≧1.5 mm and ≦3.0 mm and most preferred ≧1.8 mm and ≦2.3 mm.

FIG. 2 shows a cross-sectional schematic view through a lamp 1 according to one embodiment of the present invention. The lamp 1 comprises a lamp body 10, a burner chamber 20 and two electrodes 30, between which a light arc 40 is formed, when the lamp 1 is running. The electrodes 30 comprise a head section 60 and a cylindrical section 50 extending from the head section out of the burner chamber 20. As can be seen out of FIG. 3, the electrode head section 60 may be either essentially spherical or - as can be seen out of FIG. 4 - cylindrically in shape. As can be seen out of FIG. 5, a further suitable and preferred electrode head 60 may also comprise a cylindrical section connected to a hemispherical end part. This design is in particular advantageous for fixing the arc attachment on the tip.

The electrodes 30 are preferably made by metal injection moulding as a single piece; however the electrode head section 60 can also be connected to the cylindrical section 50 e.g. by welding or any other suitable method. Also laser-shaping techniques can be applicable.

A lamp according to the present invention is being designed for the usage in various applications, amongst them: shop lighting, home lighting, head lamps, accent lighting, spot lighting, theatre lighting, consumer TV applications, fibre-optics applications, car lighting, and projection systems.

1. Lamp, preferably a Hg-free Lamp, whereby the lamp comprises electrodes (30) with a cylindrical section (50) and a head section (60) which are adjusted such that in the initial state during run-up of the lamp under 3.2 A run-up current the average increase of electrode tip temperature for the first 25 ms after lighting of the lamp is ≦140 K/ms and ≧3 K/ms.

2. Lamp according to claim 1, whereby the lamp comprises an electrode rod (30) with a cylindrical section (50) and a head section (60) which are adjusted such that in the initial state during run-up of the lamp under 3.2 A run-up current the average increase of electrode tip temperature for the first 100 ms after lighting of the lamp is ≦50 K/ms and ≧3 K/ms.

3. Lamp according to claim 1, whereby the maximum diameter of the head section (60) is larger than the maximum diameter of the cylindrical section (50).

4. Lamp according to claim 3, whereby the maximum diameter of the cylindrical section (50) is between ≧150 μm and ≦400 μm, preferably between ≧200 μm and ≦350 μm and most preferred between ≧250 μm and ≦300 μm.

5. Lamp according to claim 3, whereby the maximum diameter of the head section (60) is between ≧250 μm and ≦800 μm, preferably between ≧350 μm and ≦600 μm and most preferred between ≧400 μm and ≦450 μm.

6. Lamp according to claim 3, whereby the head section (60) has a essentially spherical shape with preferred diameter of ≧400 and 600 μm or an essentially cylindrical shape with preferred diameter of ≧250 μm and ≦500 μm, preferably of ≧320 μm and ≦420 μm and a preferred length of ≧400 and ≦1200 μm.

7. The lamp according to claim 1, characterized in that the maximum diameter of the head section (60) is of ≧20 μm and ≦250 μm, preferably of ≧50 μm and ≦150 μm larger than the maximum diameter of the cylindrical section (50).

8. The lamp according to claim 1, characterized in that the head section (60) has a longitudinal length of ≧150 μm and ≦1500 μm, preferably of ≧400 μm and ≦1200 μm.

9. The lamp according to claim 1, characterized in that the burner chamber is divided into two essentially semi-ellipsoidal sections (A and B) and a third section (C), whereas A covers the volume, which extends from one electrode tip along this electrode to the inner wall section of the burner chamber which contains the electrode; B covers the volume, which extends from the other electrode tip along this electrode to the inner wall section which contains the electrode and section C covers the remaining volume, which is the area between the electrodes, whereby
the sections A and B have essentially the same volume; and/or
the total volume of the burner chamber is ≧15 mm³ and ≦30 mm³, preferably ≧19 mm³ and ≦25 mm³ and most preferred ≧21 mm³ and ≦23 mm³, and/or
the total volume of at least one of the sections which extends from one electrode tip along this electrode to the inner wall section of the burner chamber which contains the electrode (A;B) is ≧2 mm³ and ≦3.5 mm³, preferably ≧2.4 mm³ and ≦3.0 mm³ and most preferred ≧2.5 mm³ and ≦2.7 mm³, and/or
both sections A and B have a volume which is ≧2 mm³ and ≦3.5 mm³₁ preferably ≧2.4 mm³ and ≦3.0 mm³ and most preferred ≧2.5 mm³ and ≦2.7 mm³; and/or
the volume of the burner chamber between the two electrodes (C) is ≧10 mm³ and ≦25 mm³, preferably ≧13 mm³ and ≦20 mm³ and most preferred ≧15 mm³ and ≦18 mm³; and/or
the length of the electrodes inside the burner chamber (D) preferably is ≧1.0 mm and ≦4.0 mm, more preferably ≧1.5 mm and ≦3.0 mm and most preferred ≧1.8 mm and ≦2.3 mm.

10. A lamp according to claim 1, being designed for the usage in one of the following applications: shop lighting, home lighting, head lamps, accent lighting, spot lighting, theatre lighting, consumer TV applications, fibre-optics applications, car lighting, and projection systems.
